(19) United States
(12) Patent Application Publication
(10) Pub. No.: US 2026/0238707 A1
(43) Pub. Date: Aug. 13, 2026

(54) VEHICLE-MOUNTED RELAY DEVICE, RELAY METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(72) Inventors: Tatsuya NAKAJIMA, Yokkaichi-shi, Mie (JP); Yukihiro MIYASHITA, Yokkaichi-shi, Mie (JP); Naoto KOBAYASHI, Yokkaichi-shi, Mie (JP); Hirofumi URAYAMA, Yokkaichi-shi, Mie (JP); Tadashi MATSUMOTO, Yokkaichi-shi, Mie (JP); Makoto CHUJO, Osaka-shi, Osaka (JP); Ikuyoshi OTAKE, Toyota-shi, Aichi (JP); Yasuhiro YAMASAKI, Nisshin-shi Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(21) Appl. No.: 19/153,471

(22) PCT Filed: Feb. 2, 2024
(86) PCT No.: PCT/JP2024/003539

§ 371 Date: Nov. 25, 2025

(30) Foreign Application Priority Data
Feb. 8, 2023 (JP) 2023-017346

(51) Int. Cl. H04L 69/18; H04L 12/40

(52) U.S. Cl. CPC H04L 69/18; H04L 12/40006; H04L 2012/40215; H04L 2012/40273

(57) ABSTRACT

An in-vehicle relay device, capable of executing a relay process for communication frames, includes: a storage unit configured to store a plurality of relay tables for the relay process; a first communication unit having a plurality of communication ports, and configured to transmit and receive a first frame conforming to a first communication protocol in each of the plurality of communication ports; a second communication unit configured to transmit and receive a second frame conforming to a second communication protocol; and a control unit configured to execute the relay process regarding the first frame and the second frame. The control unit executes a selection process of selecting one relay table from among the plurality of relay tables stored in the storage unit, based on identification information included in the first frame that is transmitted from an extension device connected to any one of the plurality of communication ports.

### CROSS-REFERENCE TO RELATED APPLICATIONS

This application is the U.S. national stage of PCT/JP2024/003539 filed on Feb. 2, 2024, which claims priority of Japanese Patent Application No. JP 2023-017346 filed on Feb. 8, 2023, the contents of which are incorporated herein.

### TECHNICAL FIELD

The present disclosure relates to an in-vehicle relay device, a relay method, and a computer program.

### BACKGROUND

Japanese Laid-Open Patent Publication No. 2021-138263 discloses a technology for efficiently dealing with the number of types of communication protocols in an in-vehicle relay device capable of executing a communication frame relay process involving protocol conversion between CAN (Control Area Network: registered trademark) and Ethernet (registered trademark).

Japanese Laid-Open Patent Publication No. 2021-119724 discloses a technology for generating a communication frame suitable for information transmission to an ECU (Electronic Control Unit) connected to a CAN bus in an in-vehicle relay device that performs a communication frame relay process involving protocol conversion between CAN and Ethernet.

In the conventional in-vehicle relay device, when an extension device is added to or removed from a CAN communication port or when the connection position of the device to the communication port is changed, a maintenance technician must manually update a relay table, which results in a problem that changing the network configuration takes time.

An object of the present disclosure is to provide an in-vehicle relay device and the like that can easily change the network configuration.

### SUMMARY

A device according to one aspect of the present disclosure is an in-vehicle relay device capable of executing a relay process for communication frames, and the device includes: a storage unit configured to store a plurality of relay tables required for the relay process; a first communication unit having a plurality of communication ports, and configured to transmit and receive a first frame conforming to a first communication protocol in each of the plurality of communication ports; a second communication unit configured to transmit and receive a second frame conforming to a second communication protocol; and a control unit configured to execute the relay process regarding the first frame and the second frame. The control unit executes a selection process of selecting one relay table from among the plurality of relay tables stored in the storage unit, based on identification information included in the first frame that is transmitted from an extension device connected to any one of the plurality of communication ports.

A method according to one aspect of the present disclosure is a relay method executed by an in-vehicle relay device that is capable of executing a relay process for communication frames and includes a storage unit configured to store a plurality of relay tables required for the relay process. The method includes: transmitting and receiving a first frame conforming to a first communication protocol in at least one of a plurality of communication ports; transmitting and receiving a second frame conforming to a second communication protocol; executing the relay process regarding the first frame and the second frame; and executing a selection process of selecting one relay table from among the plurality of relay tables stored in the storage unit, based on identification information included in the first frame that is transmitted from an extension device connected to any one of the plurality of communication ports.

A computer program according to one aspect of the present disclosure is a computer program for causing a computer to function as an in-vehicle relay device capable of executing a communication frame relay process, and the computer program causes the computer to function as: a storage unit configured to store a plurality of relay tables required for the relay process; a first communication unit having a plurality of communication ports, and configured to transmit and receive a first frame conforming to a first communication protocol in each of the plurality of communication ports; a second communication unit configured to transmit and receive a second frame conforming to a second communication protocol; and a control unit configured to execute the relay process regarding the first frame and the second frame. The control unit executes a selection process of selecting one relay table from among the plurality of relay tables stored in the storage unit, based on identification information included in the first frame that is transmitted from an extension device connected to any one of the plurality of communication ports.

### Effects

According to the present disclosure, the network configuration can be easily changed.

### BRIEF DESCRIPTION OF DRAWINGS

FIG. 1 is a network configuration diagram showing an example of the configuration of an in-vehicle communication system.

FIG. 2 is a block diagram showing an example of the internal configuration of an existing-side gateway.

FIG. 3 is a block diagram showing an example of the internal configuration of an extension-side gateway.

FIG. 4 illustrates an example of a communication frame conversion process.

FIG. 5 illustrates an example of an existing-side relay table.

FIG. 6 illustrates an example of an extension-side relay table.

FIG. 7 illustrates a conventional example of a method for storing and updating a relay table.

FIG. 8 illustrates an example of a method for storing and updating a relay table.

FIG. 9 is a flowchart showing an example of a communication frame relay process on the existing side.

FIG. 10 is a flowchart showing an example of a communication frame relay process on the extension side.

### DETAILED DESCRIPTION OF PREFERRED EMBODIMENTS

Hereinafter, the outline of an embodiment of the present disclosure will be listed and described.

In a first aspect, a device is an in-vehicle relay device capable of executing a relay process for communication frames, and the device includes: a storage unit configured to store a plurality of relay tables required for the relay process; a first communication unit having a plurality of communication ports, and configured to transmit and receive a first frame conforming to a first communication protocol in each of the plurality of communication ports; a second communication unit configured to transmit and receive a second frame conforming to a second communication protocol; and a control unit configured to execute the relay process regarding the first frame and the second frame. The control unit executes a selection process of selecting one relay table from among the plurality of relay tables stored in the storage unit, based on identification information included in the first frame that is transmitted from an extension device connected to any one of the plurality of communication ports.

The relay process regarding the first frame and the second frame includes mutual relaying of the first frame and the second frame.

According to the in-vehicle relay device of such an aspect, the control unit executes the selection process of selecting one relay table from among the plurality of relay tables stored in the storage unit, based on the identification information included in the first frame transmitted from the extension device connected to any one of the plurality of communication ports.

Therefore, the relay table can be automatically updated according to addition, removal, or change in connection position of the extension device, instead of manually updating the relay table, whereby the network configuration can be easily changed.

In a second aspect, in the in-vehicle relay device the identification information is identification information of the extension device, and if the control unit is able to execute an authentication process for the extension device, the identification information, of the extension device, used for the selection process may be identification information of the extension device that is recognized to be valid in the authentication process.

In this case, a selection process using identification information of an unauthorized extension device is not executed, thereby preventing an unauthorized extension device from accessing the in-vehicle communication system.

In a third aspect, in an in-vehicle communication system including an existing network that is constructed in a standard manner in a vehicle and an extension network that is additionally constructed in the vehicle, if the in-vehicle relay device of the present embodiment belongs to the extension network, the control unit may notify another in-vehicle relay device that belongs to the existing network of identification information of the extension device recognized to be valid in the authentication process.

This allows the other in-vehicle relay device that belongs to the existing network to execute the relay table selection process by using the notified identification information of the extension device.

In a fourth aspect, in the in-vehicle relay device, if the identification information is information included in a predetermined extension target range, the control unit may exclude the first frame including the identification information not within the extension target range from targets of the relay process.

The reason is as follows. That is, the transmission source of the first frame whose identification information is outside the extension target range is not an extension device that is assumed to be extended in advance, and therefore, the first frame cannot be relayed using any of the plurality of relay tables included in the storage unit.

In a fifth aspect, in the in-vehicle relay device the plurality of relay tables may be defined so as to one-to-one correspond to a plurality of types of addition patterns when one or more extension devices are connected to the in-vehicle relay device with a predetermined topology.

Thus, addition patterns in a connection topology having, as components, one or more extension devices communicating with the first communication protocol can be limited to patterns desired by the vehicle manufacturer or the like.

In a sixth aspect, in the in-vehicle relay device, when the first communication protocol and the second communication protocol are different from each other, the control unit may execute the relay process involving protocol conversion.

In this case, even if the first communication protocol and the second communication protocol are different from each other, the first frame and the second frame can be mutually relayed

In a seventh aspect, in the in-vehicle relay device the first communication protocol may be CAN or CAN-FD, and the second communication protocol may be Ethernet.

In this case, the relay process involving protocol conversion can be performed for the first frame of CAN or CAN-FD and the second frame of Ethernet.

In an eighth aspect, in the in-vehicle relay device the identification information of the extension device may be a CAN ID.

The reason is as follows. That is, since the CAN ID is often used as the identification information of the existing device, a CAN ID should be used as the identification information of the extension device to achieve consistency.

In a ninth aspect, a method according to the present embodiment is a relay method executed by the in-vehicle relay device according to any one of the first to the eighth aspects. Therefore, the relay device of the present embodiment provides the same function and effect as those of the in-vehicle relay device according to any one of the above (1) to (8).

In a tenth aspect, a computer program is a computer program for causing a computer to function as the in-vehicle relay device according to any one of the first to the eighth aspects. Therefore, the computer program of the present embodiment provides the same function and effect as those of the in-vehicle relay device according to any one of the first to the eighth aspects.

Hereinafter, the details of the embodiment of the present disclosure will be described with reference to the drawings. At least parts of the embodiment described below may be combined as desired.

### Configuration Example of In-Vehicle Communication System

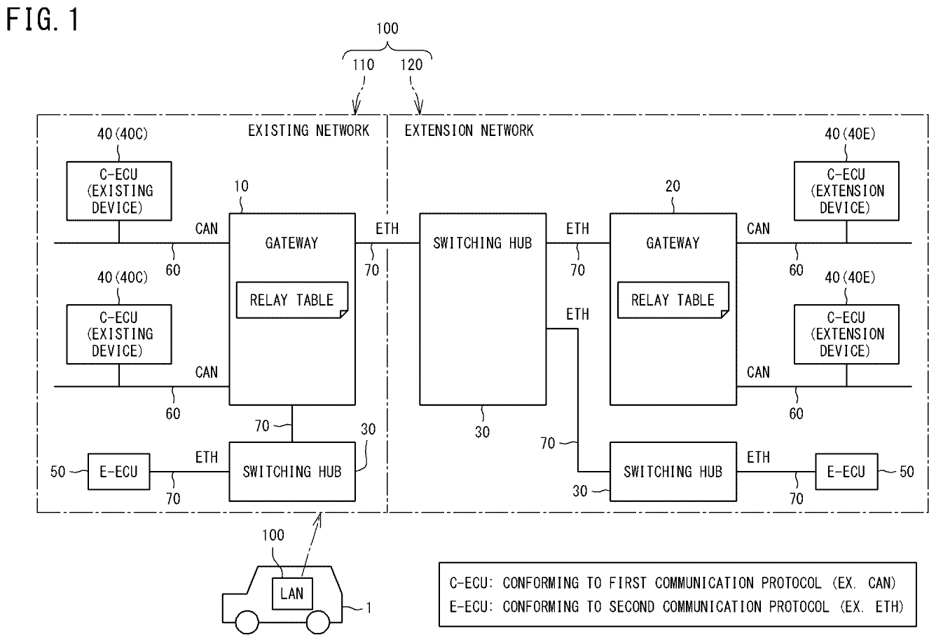

FIG. 1 is a network configuration diagram showing an example of the configuration of communication system 100.

As shown in FIG. 1, the in-vehicle communication system 100 according to the present embodiment is an in-vehicle LAN (Local Area Network) constructed inside a vehicle 1. The in-vehicle communication system 100 includes a plurality of gateways 10, 20, a plurality of switching hubs 30, a plurality of ECUs 40, 50, and the like as communication nodes constituting a network.

The ECUs 40, 50 are electronic control units which control various types of in-vehicle devices in the vehicle 1, such as sensors, actuators, and the like.

In addition, the ECUs 40, 50 are communication nodes constituting the in-vehicle communication system 100, and can be a type of “in-vehicle communication device” in terms of communication.

In terms of objects to be controlled, the types of the ECUs 40, 50 include an engine control ECU, a transmission control ECU, a power steering control ECU, an air conditioner control ECU, an AV (Audio/Visual) system control ECU, etc.

The ECUs 40, 50 capture, into the system, measurement information from sensors (a speed sensor, an acceleration sensor, a temperature sensor, a pressure sensor, etc.) connected thereto, and control various actuators (an electric motor, etc.) connected thereto, based on the measurement information.

In terms of communication protocols, the in-vehicle communication system 100 is a network in which the ECU 40 that performs communication conforming to “first communication protocol” and the ECU 50 that performs communication conforming to “second communication protocol” coexist.

As the first communication protocol, for example, CAN (Control Area Network: registered trademark), CAN-FD (CAN with flexible data rate), LIN (Local Interconnect Network), FlexRay (registered trademark), or the like can be adopted. In the present embodiment, the first protocol is “CAN”.

The type of the second communication protocol is not particularly limited as long as it is a communication protocol different from the first communication protocol.

In the present embodiment, the second communication protocol is “Ethernet” having a higher transmission speed than the first communication protocol. Hereinafter, Ethernet may be abbreviated as “ETH”.

The ECU 40 is an ECU that performs communication conforming to CAN (first communication protocol).

In the present embodiment, a communication frame conforming to CAN is referred to as “CAN frame” or “first frame”, and an ECU performing CAN communication is referred to as “C-ECU”.

The ECU 50 is an ECU that performs communication conforming to ETH (second communication protocol).

In the present embodiment, a communication frame conforming to ETH is referred to as “Ethernet (ETH) frame” or “second frame”, and an ECU performing ETH communication is referred to as “E-ECU”.

Each C-ECU 40 is connected to the gateway 10, 20 by a CAN bus 60. The CAN bus 60 is a communication line made up of high-side and low-side wirings. A plurality of C-ECUs 40 can be connected in a line to one CAN bus 60.

Each E-ECU 50 is connected to the gateway 10, 20 or the switching hub 30 by a LAN cable 70. The LAN cable 70 is, for example, a communication line corresponding to the category of CAT5 or higher that can ensure a communication speed of 100 Mbps or 1 Gbps, for example.

Each of the gateways 10, 20 is an in-vehicle relay device having: a relay function for CAN communication between different CAN buses 60; and a relay function for communication between ECUs 40, 50 (in this embodiment, “C-ECU 40” and “E-ECU 50”) using different communication protocols.

The switching hub 30 is an in-vehicle relay device capable of relaying at an L2 or L3 layer of an Ethernet frame, for example. That is, the switching hub 30 is an in-vehicle relay device conforming only to the first communication protocol.

As shown in FIG. 1, the in-vehicle communication system 100 includes an existing network 110 and an extension network 120. The existing network 110 is a network that is standardly constructed in the vehicle 1, and the extension network 120 is a network that is optionally constructed in the vehicle 1. The extension network 120 can be added when the vehicle 1 is subjected to maintenance or the like.

The need for such addition is assumed to include, for example, strengthening the safety functions of the vehicle 1, adding a new function desired by the user of the vehicle 1, and the like.

In the example shown in FIG. 1, the existing network 110 includes, as communication nodes being components thereof, one existing-side gateway 10, two C-ECUs 40 (40C), one switching hub 30, and one E-ECU 50.

However, the types and numbers of communication nodes described above are merely examples, and the actual existing network 110 may include more gateways 10, switching hubs 30, and ECUs 40, 50 than those shown in FIG. 1.

In the example shown in FIG. 1, the extension network 120 includes, as communication nodes being components thereof, one extension-side gateway 20, two switching hubs 30, two C-ECUs 40 (40E), and one E-ECU 50.

The types and numbers of communication nodes described above are also examples. For example, the gateway 20 may be connected to the gateway 10 by the LAN cable 70 or the extension-side E-ECU 50 may be connected to the gateway 10 by the LAN cable 70 without passing through the switching hub 30.

As described above, the C-ECUs 40 of the in-vehicle communication system 100 include: the C-ECU 40C already included in the existing network 110; and the C-ECU 40E that may be adopted in the future as a communication node of the extension network 120.

Therefore, in the following description, the C-ECU 40C that is a component of the existing network 110 may be referred to as “existing device 40C”, and the C-ECU 40E that can be a component of the extension network 120 may be referred to as “extension device 40E”.

### Configuration Example of Existing-Side Gateway

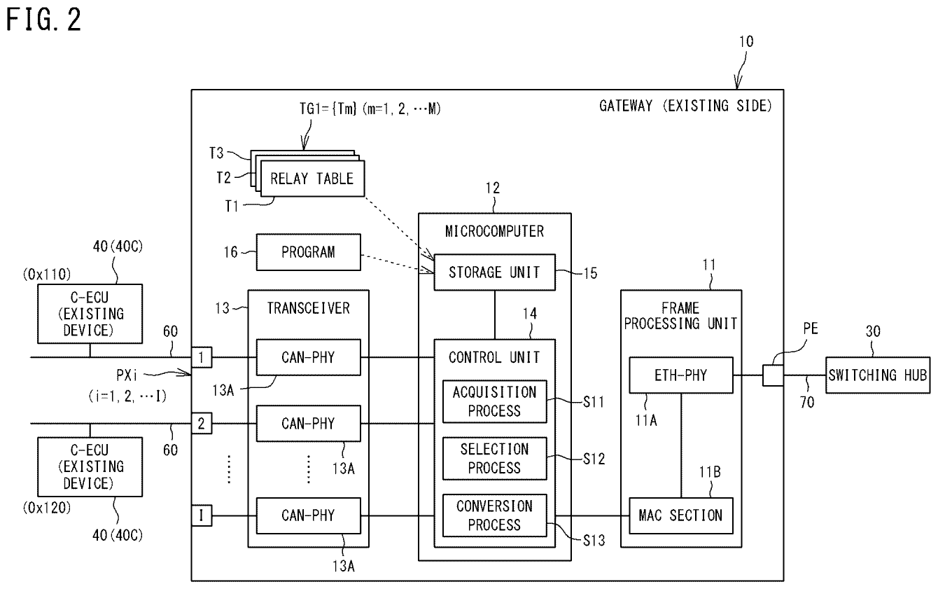

FIG. 2 is a block diagram showing an example of the internal configuration of the existing-side gateway 10.

As shown in FIG. 2, the existing-side gateway 10 includes a frame processing unit 11 for ETH communication, a microcomputer 12, and a transceiver 13 for CAN communication. In addition, the existing-side gateway 10 includes a plurality of communication ports PXi (i=1, 2 . . . I) for CAN, and one communication port PE for ETH.

The frame processing unit 11 corresponds to “second communication unit” that transmits and receives an ETH frame (second frame) conforming to the second communication protocol.

The frame processing unit 11 is composed of one or more integrated circuits that perform signal processing conforming to Ethernet, and includes a PHY section 11A and a MAC section 11B. The PHY section 11A is an integrated circuit that performs signal modulation and demodulation conforming to Ethernet, and corresponds to the communication port PE for Ethernet.

The MAC section 11B is an integrated circuit that performs signal processing relating to a MAC (Media Access Control) layer of Ethernet.

The MAC section 11B is composed of, for example, an FPGA (Field Programmable Gate Array), etc., and is electrically connected to the microcomputer 12 and the PHY section 11A.

The microcomputer 12 includes a control unit 14 and a storage unit 15.

The control unit 14 is an arithmetic processing device including one or more CPUs (Central Processing Unit) and a RAM (Random Access Memory). The control unit 14 may include another integrated circuit such as an FPGA.

The control unit 14 reads out a computer program 16 stored in the storage unit 15 onto a main memory (RAM), and executes information processing required for communication relay according to the read program 16. Details of this information processing will be described later.

The storage unit 15 is an auxiliary storage device including a non-volatile memory such as an EEPROM (Electrically Erasable Programmable ROM) or a flash ROM (Read Only Memory).

The storage unit 15 stores a relay table group TG1 in addition to the computer program 16. The relay table group TG1 includes a plurality of relay tables Tm (m=1, 2 . . . M) which are required when communication frame relay involving protocol conversion is performed. The details of the relay table group TG1 will be described later.

The transceiver 13 corresponds to “first communication unit” that transmits and receives a CAN frame (first frame) conforming to the first communication protocol.

The transceiver 13 is a transmitter-receiver that performs physical layer signal processing conforming to CAN, and includes a plurality of PHY sections 13A. Each PHY section 13A is an integrated circuit that is provided for each communication port PXi (i=1, 2 . . . I) of CAN and performs signal conversion at the L1 level of CAN.

Specifically, each PHY section 13A decodes a differential signal of the CAN bus 60 into a digital signal, and outputs the same to the control unit 14. Conversely, the PHY section 13A generates a CAN differential signal from the digital signal inputted from the control unit 14, and sends the same to the corresponding communication port PXi (CAN bus 60).

The information processing executed by the control unit 14 of the microcomputer 12 includes at least three processes as follows.
S11: An acquisition process of acquiring identification information of the extension device 40E
S12: A relay table selection process
S13: A protocol conversion process

The acquisition process S11 is a process of acquiring identification information (e.g., CAN ID) of an extension device (C-ECU) 40E that is newly added to the extension-side gateway 20.

As the acquisition process S11, a process of receiving a control frame including identification information of the authenticated extension device 40E from the extension-side gateway 20 as an external device, is adopted. In this case, the identification information of the extension device 40E can be acquired by extracting the identification information from the received control frame. As the control frame, for example, an Ethernet OAM (Operations, Administration, and Maintenance) frame or the like may be adopted.

The selection process S12 is a process of selecting one relay table Tm to be used for the communication frame relay process involving protocol conversion, from among the plurality of relay tables Tm (m=1, 2 . . . M) constituting the relay table group TG1 stored in the storage unit 15.

The selection process S12 is executed based on, for example, identification information (e.g., CAN IDs) of all the extension devices 40E notified from the gateway 20 up to the present time.

The conversion process S13 is a process of bidirectionally executing protocol conversion between CAN and ETH with reference to the one relay table Tm selected in the selection process S12.

Specifically, the control unit 14 performs “first conversion” of converting an ETH frame inputted from the frame processing unit 11 into a CAN frame, and outputs the converted CAN frame to the transceiver 13.

In this case, based on the selected one relay table Tm, the control unit 14 determines to which PHY section 13A included in the transceiver 13 (to which communication port Pxi) the converted CAN frame should be outputted.

Conversely, the control unit 14 performs “second conversion” of converting a CAN frame inputted from any PHY section 13A into an ETH frame, and outputs the converted ETH frame to the frame processing unit 11.

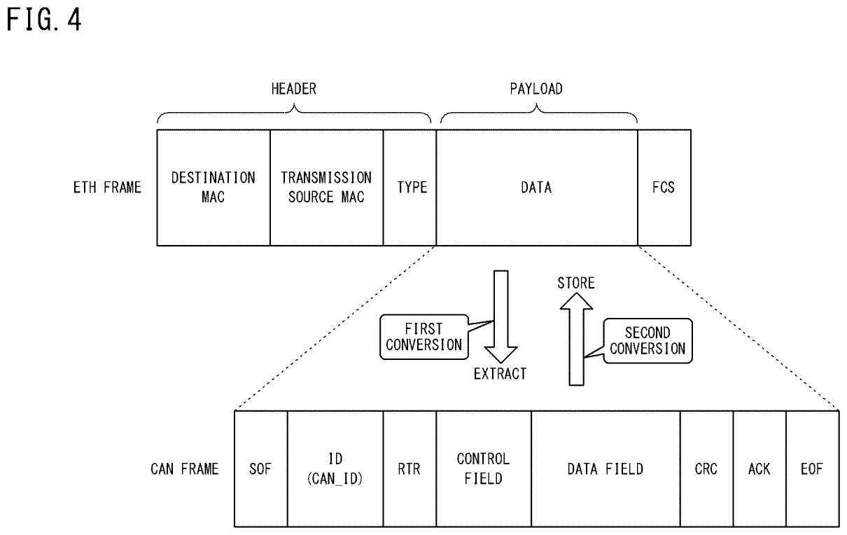

FIG. 4 illustrates an example of the communication frame conversion process S13 that the control unit 14 of the microcomputer 12 performs.

As shown in FIG. 4, here, a technique of storing all data of a CAN frame into a payload of an ETH frame is adopted.

In this case, the control unit 14 executes “first conversion” from an ETH frame to a CAN frame by extracting the CAN frame from a payload of the ETH frame inputted from the frame processing unit 11.

In addition, the control unit 14 executes “second conversion” from a CAN frame to an ETH frame by generating an ETH frame in which a CAN frame inputted from the transceiver 13 is stored in a payload.

The control unit 14 of the microcomputer 12 executes a transmission process of transmitting a converted communication frame. The transmission process by the control unit 14 includes processes as follows.

ETH transmission: A process of outputting a converted ETH frame to the frame processing unit 11.

CAN transmission: A process of outputting a converted CAN frame to the transceiver 13. In this case, a destination (transmission port PXi) of the CAN frame complies with the provisions of the relay table Tm.

### Configuration Example of Extension-Side Gateway

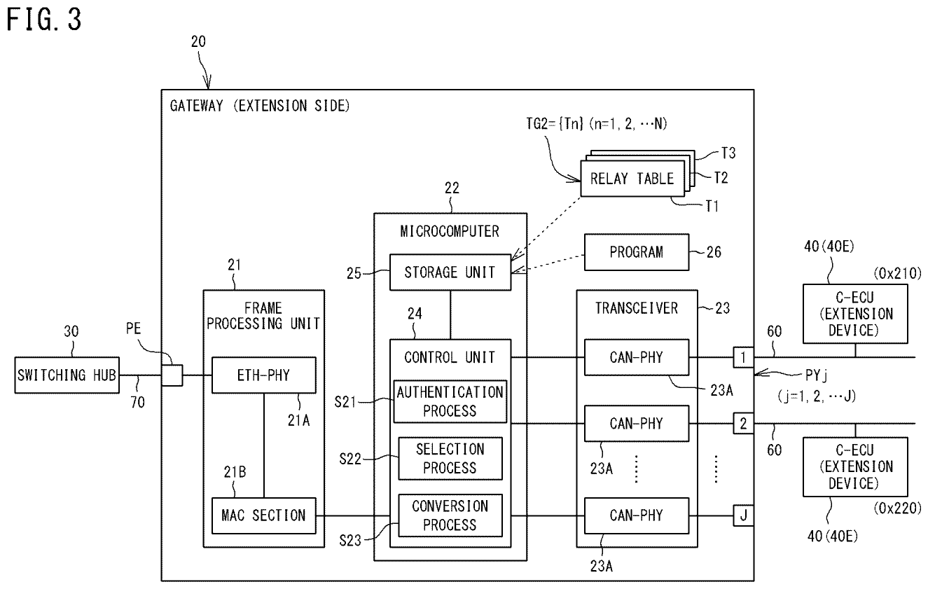

FIG. 3 is a block diagram showing an example of the internal configuration of the extension-side gateway 20.

As shown in FIG. 3, the extension-side gateway 20 includes a frame processing unit 21 for ETH communication, a microcomputer 22, and a transceiver 23 for CAN communication. In addition, the extension-side gateway 20 includes a plurality of communication ports PYj (j=1, 2 . . . J) for CAN, and one communication port PE for ETH.

The frame processing unit 21 corresponds to “second communication unit” that transmits and receives an ETH frame (second frame) conforming to the second communication protocol.

The frame processing unit 21 is composed of one or more integrated circuits that perform signal processing conforming to Ethernet, and includes a PHY section 21A and a MAC section 21B. The PHY section 21A is an integrated circuit that performs signal modulation and demodulation conforming to Ethernet, and corresponds to the communication port PE for Ethernet.

The MAC section 21B is an integrated circuit that performs signal processing relating to a MAC (Media Access Control) layer of Ethernet.

The MAC section 21B is composed of, for example, an FPGA (Field Programmable Gate Array), etc., and is electrically connected to the microcomputer 22 and the PHY section 21A.

The microcomputer 22 includes a control unit 24 and a storage unit 25.

The control unit 24 is an arithmetic processing device including one or more CPUs (Central Processing Unit) and a RAM (Random Access Memory). The control unit 24 may include another integrated circuit such as an FPGA.

The control unit 24 reads out a computer program 26 stored in the storage unit 25 onto a main memory (RAM), and executes information processing required for communication relay according to the read program 26. Details of this information processing will be described later.

The storage unit 25 is an auxiliary storage device including a non-volatile memory such as an EEPROM (Electrically Erasable Programmable ROM) or a ROM (Read Only Memory).

The storage unit 25 stores a relay table group TG2 in addition to the computer program 26. The relay table group TG2 includes a plurality of relay tables Tn (n=1, 2 . . . N) which are required when communication frame relay involving protocol conversion is performed. The details of the relay table group TG2 will be described later.

The transceiver 23 corresponds to “first communication unit” that transmits and receives a CAN frame (first frame) conforming to the first communication protocol.

The transceiver 23 is a transmitter-receiver that performs physical layer signal processing conforming to CAN, and includes a plurality of PHY sections 23A. Each PHY section 23A is an integrated circuit that is provided for each communication port PYj (j=1, 2 . . . J) of CAN and performs signal conversion at the L1 level of CAN.

Specifically, each PHY section 23A decodes a differential signal of the CAN bus 60 into a digital signal, and outputs the same to the control unit 24. Conversely, the PHY section 23A generates a CAN differential signal from the digital signal inputted from the control unit 24, and sends the same to the corresponding communication port PYj (CAN bus 60).

The information processing executed by the control unit 24 of the microcomputer 22 includes at least three processes as follows.
S21: An authentication process for the extension device 40E
S22: A relay table selection process
S23: a protocol conversion process

The authentication process S21 is a process of determining whether an extension device (C-ECU) 40E newly connected to the own device is a normal communication node.

As the authentication process S21, for example, key exchange using a message authentication code, digital signature, or the like, which is performed with the extension device 40E newly added to the CAN bus 60 being connected to the communication port PYj, may be adopted.

The selection process S22 is a process of selecting one relay table Tn to be used for the communication frame relay process involving protocol conversion, from among the plurality of relay tables Tn (n=1, 2 . . . N) constituting the relay table group TG2 stored in the storage unit 25.

The selection process S22 is executed based on, for example, the identification information (e.g., CAN IDs) of all the extension devices 40E recognized to be valid through the authentication process S1.

The conversion process S23 is a process of bidirectionally executing protocol conversion between CAN and ETH with reference to the one relay table Tn selected in the selection process S22.

Specifically, the control unit 24 performs “first conversion” of converting an ETH frame inputted from the frame processing unit 21 into a CAN frame, and outputs the converted CAN frame to the transceiver 23.

In this case, based on the selected one relay table Tn, the control unit 24 determines to which PHY section 23A included in the transceiver 23 (to which CAN bus 60) the converted CAN frame should be outputted.

Conversely, the control unit 24 performs “second conversion” of converting a CAN frame inputted from any PHY section 23A included in the transceiver 23, into an ETH frame, and outputs the converted ETH frame to the frame processing unit 21.

The conversion process shown in FIG. 4 can also be adopted as the conversion process S23 of the control unit 24.

In this case, the control unit 24 executes “first conversion” from an ETH frame to a CAN frame by extracting the CAN frame from a payload of the ETH frame inputted from the frame processing unit 21.

In addition, the control unit 24 executes “second conversion” from a CAN frame to an ETH frame by generating an ETH frame in which a CAN frame inputted from the transceiver 23 is stored in a payload.

The control unit 24 of the microcomputer 22 executes a transmission process of transmitting a converted communication frame. The transmission process by the control unit 24 includes processes as follows.

ETH transmission: A process of outputting a converted ETH frame to the frame processing unit 21

CAN transmission: A process of outputting a converted CAN frame to the transceiver 23. In this case, a destination (transmission port PYj) of the CAN frame complies with the provisions of the Relay table Tn.

### Specific example of Existing-Side Relay Table Group

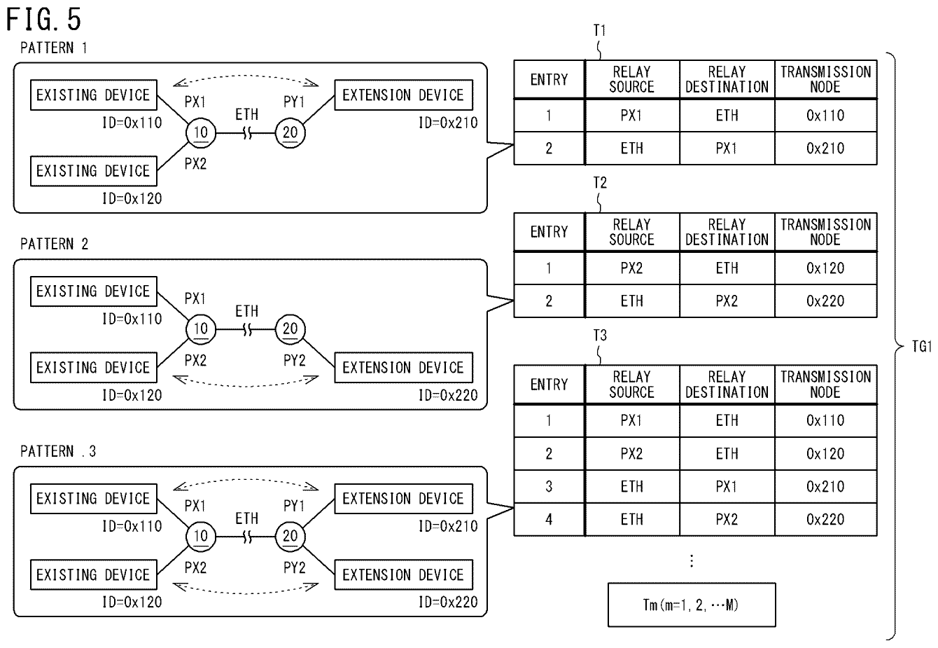

FIG. 5 illustrates an example of the relay table group TG1 on the existing side. As shown in FIG. 5, the relay table Tm (m=1, 2 . . . M) on the existing side is matrix form data in which “relay source”, “relay destination”, and “transmission node” are defined for each entry. The relay source means the type of a communication frame reception port, and the relay destination means the type of a communication frame transmission port. The transmission node means identification information of the transmission source.

In the present embodiment, assuming an increase or decrease in number of the extension device 40E on the extension side, for example, “information transmission rule” including a plurality of rules as follows is adopted.
Rule 1: Identification information (CAN ID) of an existing device has a value of 1 for the third digit from the bottom.
Rule 2: Identification information (CAN ID) of an extension device has a value of 1 for the third digit from the bottom.
Rule 3: Communication nodes, whose identification information (CAN IDs) has the same value as the second digit from the bottom, exchange information.

In the present embodiment, it is assumed that, in the existing-side gateway 10, one existing device (ID=0×110) is connected to PX1 and one existing device (ID=0×120) is connected to PX2. Furthermore, from this existing state, three types of topology patterns as follows are assumed as addition patterns of extension devices to the extension-side gateway 20.
Pattern 1: One extension device (ID=0×210) is connected to PY1.
Pattern 2: One extension device (ID=0×220) is connected to PY2.
Pattern 3: One extension device (ID=0×210) is connected to PY1 and one extension device (ID=0×220) is connected to PY2.

Of the relay table group TG1 shown in FIG. 5, a relay table TI is used for the pattern 1. In the case of pattern 1, it is enough that a relay path (dashed arrow in FIG. 5) between the existing device with ID=0×110 and the extension device with ID=0×210 is defined according to

### The Rule 3.

For this purpose, the relay table T1 includes: an entry 1 that defines transmission and reception ports in the case where a communication frame is relayed from the existing device with ID=0×110 to the extension device with ID=0×210; and an entry 2 that defines transmission and reception ports in the opposite case.

Of the relay table group TG1 shown in FIG. 5, a relay table T2 is used for the pattern 2. In the case of pattern 2, it is enough that a relay path (dashed arrow in FIG. 5) between the existing device with ID=0×120 and the extension device with ID=0×220 is defined according to the rule 3.

For this purpose, the relay table T2 includes: an entry 1 that defines transmission and reception ports in the case where a communication frame is relayed from the existing device with ID=0×120 to the extension device with ID=0×220; and an entry 2 that defines transmission and reception ports in the opposite case.

Of the relay table group TG1 shown in FIG. 5, a relay table T3 is used for the pattern 3. In the case of pattern 3, it is enough that a relay path (dashed arrow in FIG. 5) between the existing device with ID=0×110 and the extension device with ID=0×210 and a relay path (dashed arrow in FIG. 5) between the existing device with ID=0×120 and the extension device with ID=0×220 are defined according to the rule 3.

For this purpose, the relay table T3 includes: an entry 1 that defines transmission and reception ports in the case where a communication frame is relayed from the existing device with ID=0×110 to the extension device with ID=0×210; and an entry 3 that defines transmission and reception ports in the opposite case.

In addition, the relay table T3 includes: an entry 2 that defines transmission and reception ports in the case where a communication frame is relayed from the existing device with ID=0×120 to the extension device with ID=0×220; and an entry 4 that defines transmission and reception ports in the opposite case.

The relay tables Tm to be included in the relay table group TG1 are individually defined for each addition pattern assumed in advance, and are not limited to the three types shown in FIG. 5.

For example, on the extension side, when a pattern 4 in which the extension device with ID=0×210 is connected to PY2 instead of PY 1 is assumed, a relay table T4 corresponding to the pattern 4 is also included in the relay table group TG1.

When the number of extension devices to be added is K (K: natural number not less than 3), a plurality of topologies of addition patterns for connecting k (k=3, 4 . . . K) extension devices to PYj (j=1, 2 . . . J) may be specified, and a relay table Tm may be defined for each specified addition pattern.

In this way, a plurality of relay tables Tm are defined so as to one-to-one correspond to a plurality of types of addition patterns in the case where, for example, the user such as the vehicle manufacturer adds one or more extension devices to the communication port PYj of the gateway 20 with a predetermined topology.

### Specific Example of Extension-Side Relay Table Group

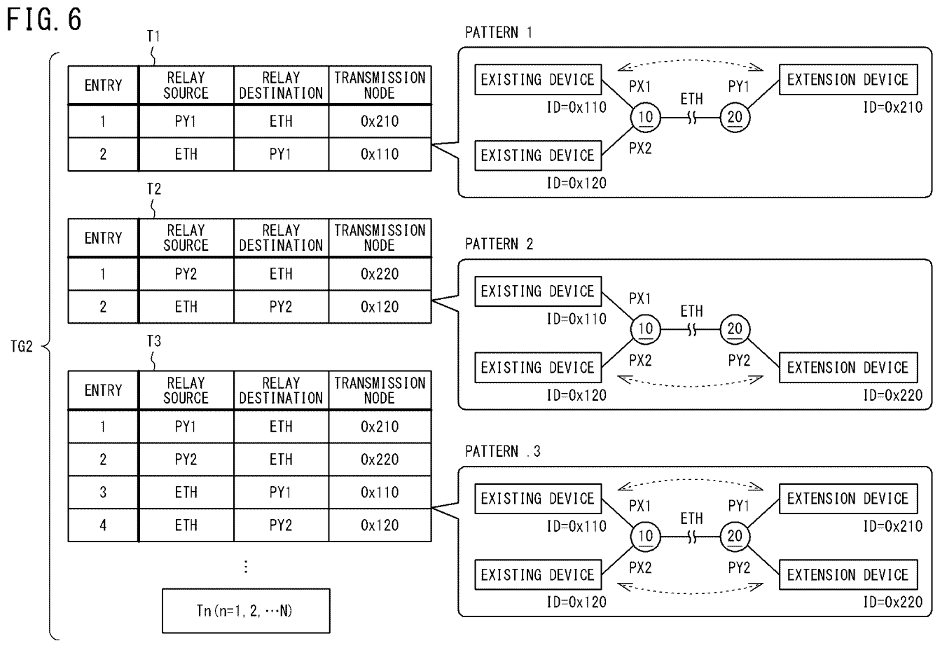

FIG. 6 illustrates an example of the relay table group TG2 on the existing side.

The relay table Tn (n=1, 2 . . . N) on the extension side shown in FIG. 6 is also matrix form data in which “relay source”, “relay destination”, and “transmission node” are defined for each entry. The relay source means the type of a communication frame reception port, and the relay destination means the type of a communication frame transmission port. The transmission node means identification information of the transmission source.

The relay table Tn shown in FIG. 6 also conforms to the above “information transmission rule”, and three types of topology patterns as follows are assumed as addition patterns on the extension side.
Pattern 1: One extension device (ID=0×210) is connected to PY1.
Pattern 2: One extension device (ID=0×220) is connected to PY2.
Pattern 3: One extension device (ID=0×210) is connected to PY1 and one extension device (ID=0×220) is connected to PY2.

Of the relay table group TG2 shown in FIG. 6, a relay table TI is used for the pattern 1. In the case of pattern 1, it is enough that a relay path (dashed arrow in FIG. 6) between the extension device with ID=0×210 and the existing device with ID=0×110 is defined according to the rule 3.

For this purpose, the relay table TI includes: an entry 1 that defines transmission and reception ports in the case where a communication frame is relayed from the extension device with ID=0×210 to the existing device with ID=0×110; and an entry 2 that defines transmission and reception ports in the opposite case.

Of the relay table group TG2 shown in FIG. 6, a relay table T2 is used for the pattern 2. In the case of pattern 2, it is enough that a relay path (dashed arrow in FIG. 6) between the extension device with ID=0×220 and the existing device with ID=0×120 is defined according to the rule 3.

For this purpose, the relay table T2 includes: an entry 1 that defines transmission and reception ports in the case where a communication frame is relayed from the extension device with ID=0×220 to the existing device with ID=0×120; and an entry 2 that defines transmission and reception ports in the opposite case.

Of the relay table group TG2 shown in FIG. 6, a relay table T3 is used for the pattern 3. In the case of pattern 3, it is enough that a relay path (dashed arrow in FIG. 6) between the extension device with ID=0×210 and the existing device with ID=0×110 and a relay path (dashed arrow in FIG. 6) between the extension device with ID=0×220 and the existing device with ID=0×120 are defined according to the rule 3.

For this purpose, the relay table T3 includes: an entry 1 that defines transmission and reception ports in the case where a communication frame is relayed from the extension device with ID=0×210 to the existing device with ID=0×110; and an entry 3 that defines transmission and reception ports in the opposite case.

In addition, the relay table T3 includes: an entry 2 that defines transmission and reception ports in the case where a communication frame is relayed from the extension device with ID=0×220 to the existing device with ID=0×120; and an entry 4 that defines transmission and reception ports in the opposite case.

The relay tables Tn to be included in the relay table group TG2 are individually defined for each addition pattern assumed in advance, and are not limited to the three types shown in FIG. 6.

For example, on the extension side, when a pattern 4 in which the extension device with ID=0×210 is connected to PY2 instead of PY1 is assumed, a relay table T4 corresponding to the pattern 4 is also included in the relay table group TG2.

When the number of extension devices to be added is K (K: natural number not less than 3), a plurality of topologies of addition patterns for connecting k (k=3, 4 . . . K) extension devices to PYj (j=1, 2 . . . J) may be specified, and a relay table Tn may be defined for each specified addition pattern.

In this way, a plurality of relay tables Tn are defined so as to one-to-one correspond to multiple types of addition patterns in the case where, for example, the user such as the vehicle manufacturer adds one or more extension devices to the communication port PYj of the gateway 20 with a predetermined topology.

### Problems of Conventional Gateway and Method for Solving the Same

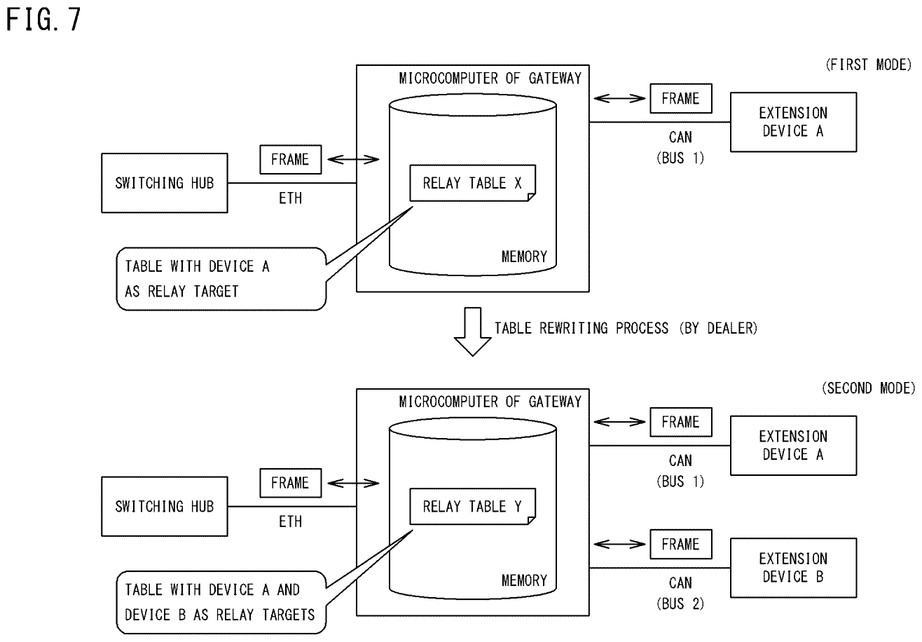

FIG. 7 illustrates a conventional example of a method for storing and updating relay tables X, Y.

As shown in FIG. 7, the relay table X is a table defined so that only an extension device A is a relay target, and the relay table Y is a table defined so that an extension device A and an extension device B are relay targets.

Unlike LANs in buildings such as an office LAN and a home LAN, in an in-vehicle LAN, the frequency at which communication nodes such as C-ECUs are added, removed, or changed with respect to their connection positions is relatively low.

For this reason, in the conventional gateway performing a relay process involving protocol conversion, only one relay table X, Y is stored in the memory of the microcomputer.

Therefore, as shown in FIG. 7, when changing from “first mode” in which the extension device A is connected to a CAN bus 1 to “second mode” in which the extension device B is additionally connected to a CAN bus 2, a process of rewriting a relay table A to a relay table B is required.

Such rewriting from the relay table A to the relay table B must be manually done by, for example, a maintenance technician of the vehicle 1 using a monitoring tool such as a command line, with a terminal device for management (e.g., notebook PC) being connected to the gateway, which takes time and labor.

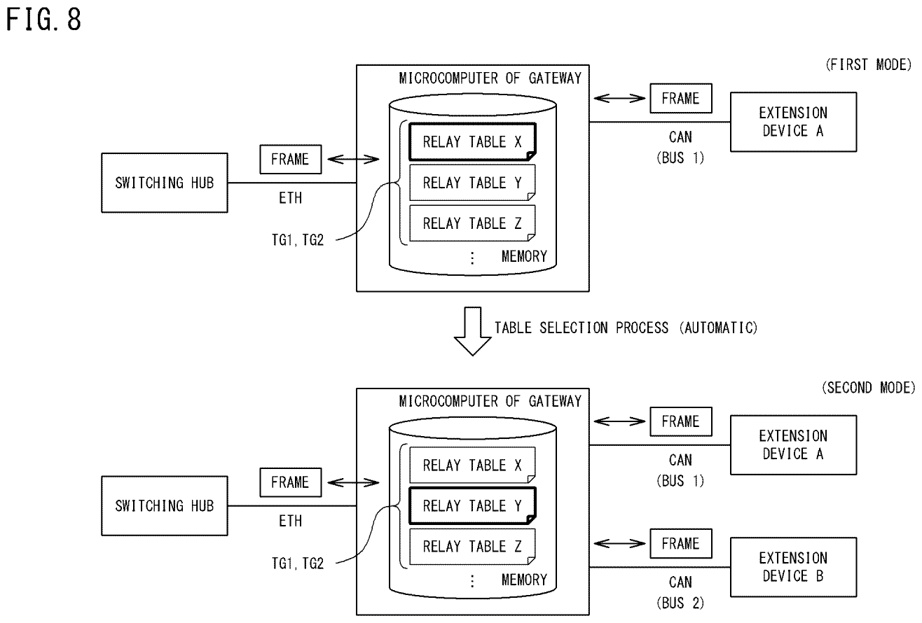

FIG. 8 illustrates an example of a method for storing and updating relay tables X, Y, Z.

As shown in FIG. 8, the relay table X is a table defined so that only an extension device A is a relay target, and the relay table Y is a table defined so that the extension device A and an extension device B are relay targets.

As described above, in the present embodiment, the relay tables X, Y are stored in the memory of the microcomputer as the relay table groups TG1, TG2 together with another relay table Z.

Therefore, as shown in FIG. 8, when changing from the “first mode” in which the extension device A is connected to the CAN bus 1 to the “second mode” in which the extension device B is additionally connected to the CAN bus 2, it is enough to select the required relay table Y from the relay table groups TG1, TG2.

The microcomputer can automatically execute such a selection process for the relay tables X, Y, based on, for example, identification information of the newly connected extension device B.

As described above, according to the present embodiment, the relay table groups TG1, TG2, each being a collection of relay tables X, Y, Z for each assumable addition pattern, are stored in the memory of the microcomputer, and the microcomputer selects the required relay table Y according to, for example, the identification information of the extension devices A, B. Therefore, the relay tables X, Y, Z can be updated automatically by plug-and-play.

Therefore, the extension devices A, B can be added, removed, or changed with respect to their connection positions without manually rewriting the relay tables X, Y, Z, which results in an advantage that the network configuration can be easily changed.

In addition, by performing CAN transmission according to the relay tables X, Y, Z, a CAN frame is not broadcast but is relayed only to the CAN bus to which the extension devices A, B are connected, which results in an advantage that the bus load is reduced and security is improved.

### Communication Frame Relay Process on Existing Side

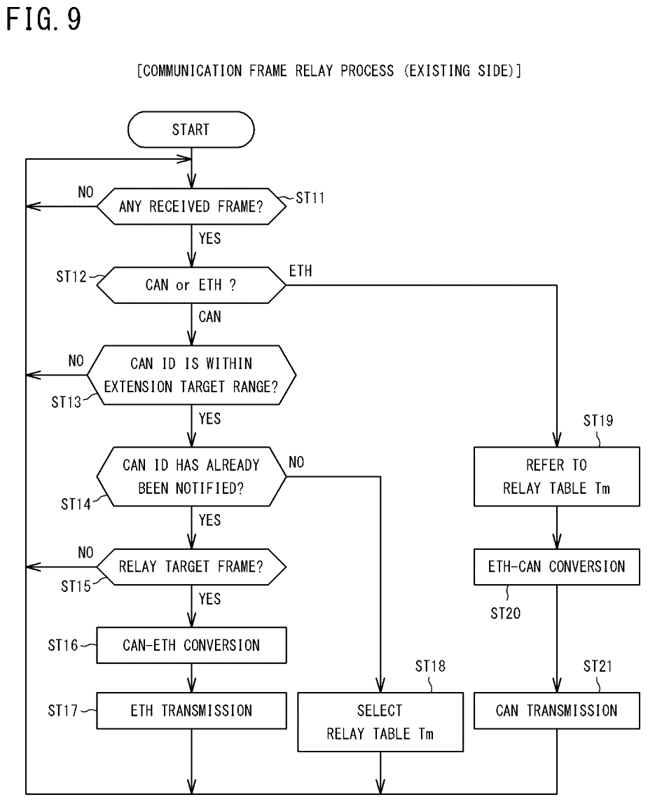

FIG. 9 is a flowchart showing an example of an existing-side communication frame relay process that is executed by the control unit 14 of the existing-side gateway 10.

The relay process shown in FIG. 9 is a process of relaying a communication frame that is used for information exchange between an existing device (C-ECU) 40C and an extension device (C-ECU) 40E, and uses the relay table group TG1 (FIG. 5). The relay process does not include relaying between the CAN buses 60 which does not require protocol conversion.

As shown in FIG. 9, the control unit 14 of the gateway 10 monitors whether there is a received frame (step ST11), and when a received frame has been detected, determines whether the received frame is a CAN frame or an ETH frame (step ST12).

When the determination result in step ST12 is “CAN”, the control unit 14 determines whether the value of the CAN ID included in the CAN frame is within an extension target range (step ST13).

The extension target range is a numerical range of CAN IDs (e.g., 0×100 to 0×400) assigned to the extension devices 40E in advance.

When the determination result in step ST13 is negative, the control unit 14 skips steps ST14 to ST18, and returns the process to before step ST11.

The reason is as follows. That is, the transmission source of a CAN frame whose CAN ID value is outside the extension target range is not an extension device 40E that is assumed to be extended in advance, and therefore, the CAN frame cannot be relayed using any of the relay tables Tm included in the relay table group TG1.

When the determination result in step ST13 is positive, the control unit 14 determines whether the CAN ID included in the CAN frame is an ID that has already been notified from the extension-side gateway 20 (step ST14).

When the determination result in step ST14 is positive, the control unit 14 determines whether the CAN frame is a relay target frame from CAN to ETH (step ST15). The relay target frame is a CAN frame having a CAN ID included in the relay table Tm that is currently selected.

When the determination result in step ST15 is negative, the control unit 14 skips steps ST16 and ST17 and returns the process to before step ST11.

The reason is as follows. That is, the transmission source of the CAN ID not existing in the current relay table Tm may be a communication frame from an unauthorized transmission source, and therefore, a relay process using the relay table Tm should not be performed.

When the determination result in step ST15 is positive, the control unit 14 subjects the received CAN frame to a conversion process from CAN to ETH (step ST16).

The above conversion process corresponds to the second conversion of storing the received CAN frame into a payload of an ETH frame (see FIG. 4).

Next, the control unit 14 executes a transmission process for the converted ETH frame (step ST17) and then returns the process to before step ST11. The above transmission process is a process of outputting the converted ETH frame to the frame processing unit 21.

When the determination result in step ST14 is negative, this means that the CAN ID of an authenticated new extension device 40E has been notified, and therefore, the control unit 14 performs a selection process for the relay table Tm, based on the notified CAN ID (step ST18).

The above selection process is performed based on all the CAN IDs having been notified until the present time. Specifically, the selection process in step ST18 includes the following steps, for example.
Step 1: The existing-side CAN IDs having the same value of the second digit from the bottom as all the extension-side CAN IDs notified by the gateway 20, including the current notification, are read from the memory.
Step 2: At least one relay table Tm in which the CAN IDs read out in step 1 are included in the “transmission node” field is extracted from the relay table group TG1.
Step 3: If the number of relay tables Tm extracted in step 2 is one, the extracted relay table Tm is determined as the relay table Tm to be selected.
Step 4: If a plurality of relay tables Tm are extracted in step 2, a relay table Tm in which the port numbers of a plurality of PXi being currently operated match a plurality of port numbers included in the “transmission node” field is determined as the relay table Tm to be selected.

When the determination result in step ST12 is “ETH”, the control unit 14 refers to the current relay table Tm (step ST19), and subjects the received ETH frame to a conversion process from ETH to CAN (step ST20).

The above conversion process corresponds to the first conversion of extracting the CAN frame from the payload of the received ETH frame (see FIG. 4).

Next, the control unit 14 executes a transmission process for the converted CAN frame (step ST21), and returns the process to before step ST11. The above transmission process includes the following procedures, for example.
Procedure 1: An entry in which the CAN ID value read from the converted CAN frame is entered in the “transmission node” field is extracted from the relay table Tm.
Procedure 2: The port number of PXi is read from the “relay destination” field in the extracted entry, and the converted CAN frame is outputted to the CAN-PHY section 13A corresponding to the port number.

### Communication Frame Relay Process on Extension Side

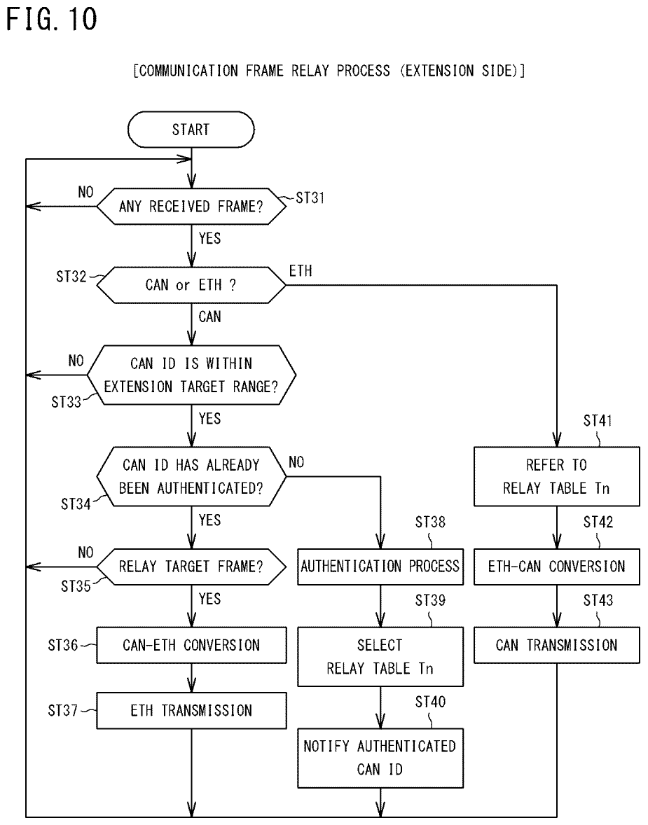

FIG. 10 is a flowchart showing an example of an extension-side communication frame relay process that is executed by the control unit 24 of the extension-side gateway 20.

The relay process shown in FIG. 10 is a process of relaying a communication frame used for information exchange between an existing device (C-ECU) 40C and an extension device (C-ECU) 40E, and the relay process uses the relay table group TG2 (FIG. 6). The relay process does not include relaying between the CAN buses 60 which does not require protocol conversion.

As shown in FIG. 10, the control unit 24 of the gateway 20 monitors whether there is a received frame (step ST31), and when a received frame has been detected, determines whether the received frame is a CAN frame or an ETH frame (step ST32).

When the determination result in step ST32 is “CAN”, the control unit 24 determines whether the value of the CAN ID included in the CAN frame is within an extension target range (step ST33).

The extension target range is a numerical range of CAN IDs (e.g., 0×100 to 0×400) assigned to the extension devices 40E in advance.

When the determination result in step ST33 is negative, the control unit 24 skips steps ST34 to ST40, and returns the process to before step ST31.

The reason is as follows. That is, the transmission source of a CAN frame whose CAN ID value is outside the extension target range is not an extension device 40E that is assumed to be extended in advance, and therefore, the CAN frame cannot be relayed using any of the relay tables Tn included in the relay table group TG2.

When the determination result in step ST33 is positive, the control unit 24 determines whether the CAN ID included in the CAN frame has already been authenticated (step ST34).

When the determination result in step ST34 is positive, the control unit 24 determines whether the CAN frame is a relay target frame from CAN to ETH (step ST35). The relay target frame is a CAN frame having a CAN ID included in the relay table Tn that is currently selected.

When the determination result in step ST35 is negative, the control unit 24 skips steps ST36 and ST37 and returns the process to before step ST31.

The reason is as follows. That is, the transmission source of the CAN ID not existing in the current relay table Tn may be a communication frame from an unauthorized transmission source, and therefore, a relay process using the relay table Tn should not be performed.

When the determination result in step ST35 is positive, the control unit 24 subjects the received CAN frame to a conversion process from CAN to ETH (step ST36).

The above conversion process corresponds to the second conversion of storing the received CAN frame into a payload of an ETH frame (see FIG. 4).

Next, the control unit 24 executes a transmission process for the converted ETH frame (step ST37) and then returns the process to before step ST31. The above transmission process is a process of outputting the converted ETH frame to the frame processing unit 21.

When the determination result in step ST34 is negative, the control unit 24 performs an authentication process with the extension device 40E that is not yet authenticated (step ST38). The control unit 24 acquires the CAN ID of the new extension device 40E through information exchange during the authentication process.

Next, the control unit 24 performs a selection process for the relay table Tn, using the CAN ID of the extension device 40E having been authenticated (step ST39).

The above selection process is performed based on all the CAN IDs having been notified until the present time. Specifically, the selection process in step ST39 includes the following steps, for example.
Step 1: All the CAN IDs having been authenticated, including the current authentication, are read from the memory.
Step 2: At least one relay table Tn in which the CAN IDs read in step 1 are included in the “transmission node” field is extracted from the relay table group TG2.
Step 3: If the number of relay tables Tn extracted in step 2 is one, the extracted relay table Tn is determined as the relay table Tn to be selected.
Step 4: If a plurality of relay tables Tn are extracted in step 2, a relay table Tn in which the port numbers of a plurality of PYj being currently operated match a plurality of port numbers included in the “transmission node” field is determined as the relay table Tn to be selected.

Next, the control unit 24 notifies the existing-side gateway 10 of the currently authenticated CAN ID (step ST40) and then returns the process to before step ST31.

Specifically, the control unit 24 generates an Ethernet control unit frame (e.g., Ethernet OAM frame) including the authenticated CAN ID and addressed to the gateway 10, and outputs the generated control frame to the frame processing unit 21.

When the determination result in step ST32 is “ETH”, the control unit 24 refers to the current relay table Tn (step ST41), and subjects the received ETH frame to a conversion process from ETH to CAN (step ST42).

The above conversion process corresponds to the first conversion of extracting the CAN frame from the payload of the received ETH frame (see FIG. 4).

Next, the control unit 24 executes a transmission process for the converted CAN frame (step ST43) and then returns the process to before step ST31. The above transmission process includes the following procedures, for example.
Procedure 1: An entry in which the CAN ID value read from the converted CAN frame is entered in the “transmission node” field is extracted from the relay table Tn.
Procedure 2: The port number of PYj is read from the “relay destination” field in the extracted entry, and the converted CAN frame is outputted to the CAN-PHY section 23A corresponding to the port number.

### First Modification

In the above embodiment, CAN IDs (i.e., base IDs of CAN) are used as identification information for “transmission nodes” on the relay tables Tm, Tn, but identification information for transmission nodes may be identifiers other than CAN IDs.

Any identification information for transmission nodes may be used as long as it can individually identify a device. For example, a product ID assigned to an ECU by a manufacturer, a serial number assigned to a product by a manufacturer, or the like may be used.

If a product ID, a serial number, or the like is used as identification information of a transmission node, for example, a CAN control area or an extension ID may be used as a definition area.

However, in the existing network 110, CAN IDs are often used as identification information for the existing devices 40C. Therefore, in terms of achieving consistency between the existing side and the extension side, it is preferable to use CAN IDs as identification information for the existing devices 40C and the extension devices 40E.

### Second Modification

In the above embodiment, a CAN ID may be defined as identification information for the type of data to be transmitted, rather than as identification information of a transmission node (transmission source).

In this case, the relay tables Tm, Tn may each be in a format including fields of “relay source”, “relay destination”, and “data type”. This allows each of the relay tables Tm, Tn to be a table that defines to which CAN bus 60 in the relay destination the data to be transmitted should be transmitted.

### Third Modification

In the above embodiment, the types of the first communication protocol and the second communication protocol are not limited to the combination of CAN and ETH, and may be any of the following combination examples.
Combination example 1: A combination of CAN and USB (Universal Serial Bus: USB is a registered trademark). In this case, the first communication protocol may be CAN and the second communication protocol may be USB, or vice versa.
Combination example 2: A combination of USB and ETH. In this case, the first communication protocol may be USB and the second communication protocol may be ETH, or vice versa.

### Fourth Modification

In the above embodiment, the first communication protocol and the second communication protocol may not necessarily be different types of protocols such as CAN and ETH, and may be protocols of the same type. For example, both the first communication protocol and the second communication protocol may be CAN, USB, or ETH.

In this case, the control units 14, 24 of the gateways 10, 20 need not perform a protocol conversion process for a communication frame when relaying the communication frame (e.g., FIG. 4).

### Other Modifications

The embodiment disclosed herein is merely illustrative and not restrictive in all aspects. The scope of the present disclosure is not limited to the above-described embodiment, and all changes which come within the range of equivalency of the configurations recited in the claims are therefore intended to be included therein.

In the above embodiment, the in-vehicle relay device may be a relay device, having a plurality of Ethernet ports, which is configured by housing the gateways 10, 20 and one or more switching hubs 30 in one housing.

In the above embodiment, the microcomputer 12, 22 of the gateway 10, 20 executes both the relay process between the CAN buses 60 not involving protocol conversion and the relay process involving protocol conversion between CAN and ETH, but these relay processes may be shared and executed by different microcomputers (integrated circuit).

In the above embodiment, the existing device 40C and the extension device 40E may not necessarily be ECUs, and may be, for example, in-vehicle devices, other than ECUs, capable of independently performing CAN communication, such as sensors or actuators having a function of CAN communication.

1. An in-vehicle relay device capable of executing a relay process for communication frames, comprising:
a storage unit configured to store a plurality of relay tables required for the relay process;
a first communication unit having a plurality of communication ports, and configured to transmit and receive a first frame conforming to a first communication protocol in each of the plurality of communication ports;
a second communication unit configured to transmit and receive a second frame conforming to a second communication protocol; and
a control unit configured to execute the relay process regarding the first frame and the second frame, wherein
the control unit executes a selection process of selecting one relay table from among the plurality of relay tables stored in the storage unit, based on identification information included in the first frame that is transmitted from an extension device connected to any one of the plurality of communication ports.

2. The in-vehicle relay device according to claim 1, wherein
the identification information is identification information of the extension device,
the control unit is able to execute an authentication process for the extension device, and
the identification information, of the extension device, used for the selection process is identification information of the extension device that is recognized to be valid in the authentication process.

3. The in-vehicle relay device according to claim 2, wherein
in an in-vehicle communication system including an existing network that is standardly constructed in a vehicle and an extension network that is additionally constructed in the vehicle, the in-vehicle relay device belongs to the extension network, and
the control unit notifies another in-vehicle relay device that belongs to the existing network of identification information of the extension device recognized to be valid in the authentication process.

4. The in-vehicle relay device according to claim 1, wherein
the identification information is information included in a predetermined extension target range, and
the control unit excludes the first frame including the identification information not within the extension target range from targets of the relay process.

5. The in-vehicle relay device according to claim 1, wherein
the plurality of relay tables are defined so as to one-to-one correspond to a plurality of types of addition patterns when one or more extension devices are connected to the in-vehicle relay device with a predetermined topology.

6. The in-vehicle relay device according to claim 1, wherein
when the first communication protocol and the second communication protocol are different from each other,
the control unit executes the relay process involving protocol conversion.

7. The in-vehicle relay device according to claim 1, wherein
the first communication protocol is CAN or CAN-FD, and
the second communication protocol is Ethernet.

8. The in-vehicle relay device according to claim 1, wherein
identification information of the extension device is a CAN ID.

9. A relay method executed by an in-vehicle relay device that is capable of executing a relay process for communication frames and includes a storage unit configured to store a plurality of relay tables required for the relay process, the method comprising;
transmitting and receiving a first frame conforming to a first communication protocol in at least one of a plurality of communication ports;
transmitting and receiving a second frame conforming to a second communication protocol;
executing the relay process regarding the first frame and the second frame; and
executing a selection process of selecting one relay table from among the plurality of relay tables stored in the storage unit, based on identification information included in the first frame that is transmitted from an extension device connected to any one of the plurality of communication ports.

10. A non-transitory computer readable storage medium storing a computer program for causing a computer to function as an in-vehicle relay device capable of executing a communication frame relay process, the computer program causing the computer to function as:
a storage unit configured to store a plurality of relay tables required for the relay process;
a first communication unit having a plurality of communication ports, and configured to transmit and receive a first frame conforming to a first communication protocol in each of the plurality of communication ports;
a second communication unit configured to transmit and receive a second frame conforming to a second communication protocol; and
a control unit configured to execute the relay process regarding the first frame and the second frame, wherein
the control unit executes a selection process of selecting one relay table from among the plurality of relay tables stored in the storage unit, based on identification information included in
the first frame that is transmitted from an extension device connected to any one of the plurality of communication ports.
